(19) United States
(12) Patent Application Publication
(10) Pub. No.: US 2013/0191348 A1
(43) Pub. Date: Jul. 25, 2013

(54) METHOD AND DEVICE FOR "TRACING MULTIMEDIA FILE COPIES"

(71) Applicant: Ali Vahabzadegan, Tehran (IR)

(72) Inventor: Ali Vahabzadegan, Tehran (IR)

(21) Appl. No.: 13/357,298

(22) Filed: Jan. 24, 2012

(51) Int. Cl. G06F 7/00

(52) U.S. Cl. 707/675; 707/E17.101

(57) ABSTRACT

A method and system for identifying and tracing copies of a file is disclosed herein. The method/system includes assigning a unique serial number to each of the copies of the file; and designating a barcode corresponding to the unique serial number. The method/system requires identification of a purchaser of a given copy to be linked with the barcode, so that it can reference the association relations between the serial number and barcode to determine the identity of the purchaser.

### BACKGROUND OF THE INVENTION

This invention relates to a method and device for identifying and tracing copies of a multimedia file, whether authorized or not.

Given the rapid technology development in duplicating and disseminating multimedia data across the internet nowadays, the art currently available does not afford full protection on the works that are carried over the multimedia data.

Conventional attempts at enhancing the intellectual property right (“IPR”) protection have integrated cryptography with watermarking technologies to limit data access to only authorized users. Although cryptography ensures confidentiality and integrity of the encrypted data, it fails to prevent or trace unauthorized copying once the protected data has been transmitted.

Another common technique to protect the multimedia data is digital watermarking. A digital watermark is embedded in the data to uniquely identify the data's owner (the IPR data). This technique can only tell or identify the IPR owner of a copy but cannot trace pirating activities and/or unauthorized copier(s).

Various other techniques for protecting the IPR data, involve operating in a predetermined manner or examining the machine or device that performs the IPR data. Such techniques require fundamental infrastructure change and unnecessary burden in implementing them. Examples include the techniques disclosed in U.S. Patent Publication No. 2009/0080654, to Pri-or; U.S. Patent Publication No. 2008/0215633 to Dunkeld et al; and U.S. Patent Publication No. 2010/0185306, to Rhoads.

### SUMMARY OF THE INVENTION

Given the above deficiencies of prior art, there is a need for a method and apparatus for identifying and tracing copies of a multimedia file so as to prevent pirating. The present invention achieves this goal by way of embedding a unique identifier into each copy of the multimedia data so that the IPR owner can trace the origin of any unauthorized copying with the corresponding unique identifier.

The inventive method disclosed herein includes generating a respective identification number for each of the copies of the multimedia file; designating a barcode identifier corresponding to the identification number of the copy; and storing the association relation between the identification number and barcode identifier, in a data store such as a database table. The method further includes embedding the identification number into the copy's data.

When the multimedia copy is distributed and/or sold, the barcode identifier is linked with the copy's distribution information, such as identity and credit card information of the copy's purchaser. Such association relationship of the barcode identifier and the purchaser's identity is saved in a data store, such as a database table. Therefore, if any unauthorized copying of the multimedia data is found, the IPR holder can read the duplicate's data with the identification number embedded therein so as to identify the source of the copying using the correlation tables.

Advantageously, this innovative method embeds the identification number employing the following steps: converting the identification number into binary codes; designating a value in audio intensity respectively for bits 1 and 0; and modifying audio intensity of at least a sequence of the copy's data in accordance with the corresponding value for each of the binary codes.

The audio modification is preferably made gradually by increasing and decreasing in increments audio intensity of the sequence data in accordance with the corresponding value for each of the binary codes.

In some implementations, a value in audio intensity is designated for the start and end of the sequence data and used for modifying the start and the end portions of the sequence data. The value is distinguishable from the values representing bits 1 and 0. Advantageously, audio intensity is left unchanged of a portion of the data subsequent to each portion of the data that has been modified corresponding to each of the binary codes.

These and other features and advantages of this invention will become further apparent from the detailed description and accompanying figures that follow. In the figures and description, numerals indicate the various features of the invention, like numerals referring to like features throughout both the drawings and the description.

### BRIEF DESCRIPTION OF THE DRAWINGS

FIG. 1 illustrates an exemplary embodiment of Multimedia Serial Number Tracing System according to the present invention.

FIG. 2 is a flowchart depicting functions of an exemplary embodiment of the Tracing System according to the present invention.

FIG. 3 illustrates an example of embedding a given serial number to a multimedia file copy, in accordance with a preferred embodiment of the current invention.

FIG. 4 shows an example of embedding a given serial number to a multimedia file copy, in a progressive manner.

FIG. 5 depicts an example of embedding “Space” symbol to separate individual binary codes, in accordance with one embodiment of the present invention.

FIG. 6 is a block diagram of an exemplary architecture 800 that the present invention can be implemented upon.

### DETAILED DESCRIPTION OF THE PREFERRED EMBODIMENT(S)

One of the most serious problems that the audio/audio-visual production industry faces nowadays is how to prevent unauthorized copying of multimedia content. To effectively address this concern, the present invention disclosed herein provides a method and a system for tracing copies of a multimedia file and identifying the source of illegal duplicating. The present invention, as can be comprehended by persons of ordinary skills in the art, supports all kinds of digital files and/or electronic documents, not limited to only those carrying multimedia content.

The present invention is beneficially applicable to multimedia files in various formats such as MP3 (Moving Pictures Experts Group (MPEG) Audio Layer 3), CD-DA (Compact Disk-Digital Audio), Windows® Media Audio, whether disseminated over the Internet or recorded in medium such as CD-R (Compact Disk—ReWritable), DVD-R (DVD-Recordable) or DVD-RW (DVD-ReWritable). The innovative system/method is superior to other resolutions intended to prevent or detect pirating of the copyrighted data partly in that it is capable of tracing the source of unauthorized duplicating regardless of types of distribution channels through which the original copies have been disseminated. Common distribution channels that the present invention is applicable to and supports include, by way of example, internet commerce, traditional wholesaler and retail stores or shops.

This innovative system/method is designed to utilize barcodes as means for tracking buyer of a given multimedia file so when illegal copying of the file is discovered, law enforcement or concerned parties can use this system/method to readily identify the source of copying. A barcode is an optical machine-readable representation of data, which is attached to a commodity item, such as CD-R, DVD-R or DVD-RW that carries multimedia files. As barcodes have been widespread in modern commerce, the present invention can be effortlessly implemented in the multimedia production or distribution industry.

According to one embodiment of the present invention, identification of unauthorized copying source is achieved by tracking down the distribution of a barcode attached to one or more given multimedia files each having a unique serial number. For instance, when a given instance of an audio file is purchased online, the buyer identification such as credit card information is recorded and linked to the barcode of the instance. As described earlier, the barcode of the instance is associated with a unique serial number embedded in the digital data of the instance. Once any unauthorized copying is discovered, the present invention can retrieve the unique serial number from the data of an illegal copy and then match the corresponding barcode as well as the buyer identification using the serial number.

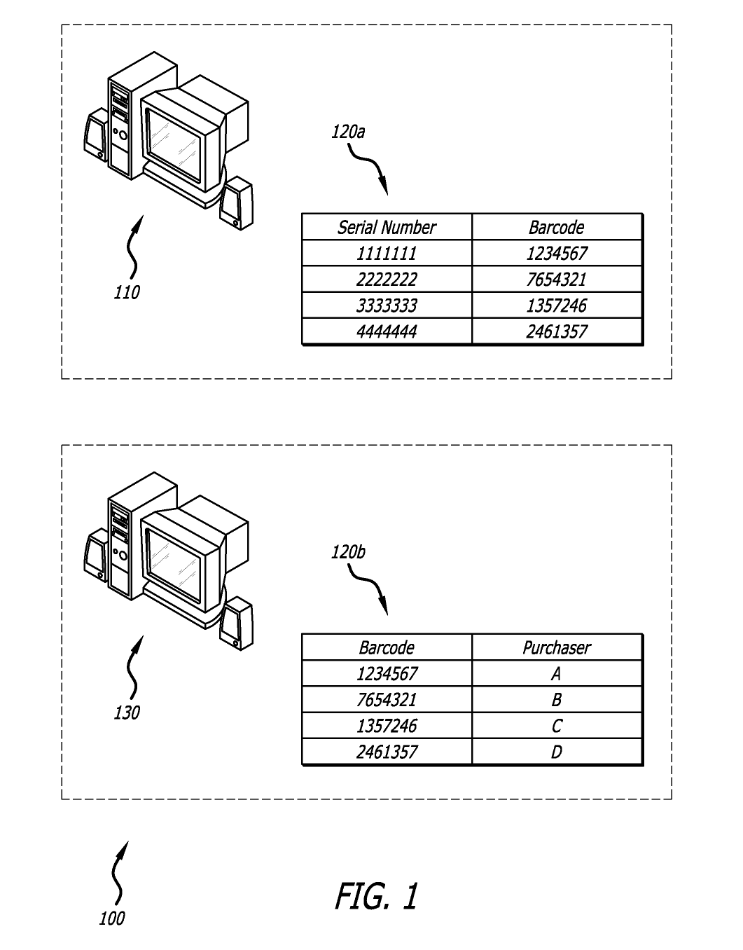

FIG. 1 illustrates an exemplary embodiment of Multimedia Serial Number Tracing System 100 according to the present invention. The Tracing System 100 is advantageously implemented on multiple software programs or applications that run on one or more information processing systems such as computers (including network servers, regular desktops or laptops), pocket PCs, personal digital assistants (PDA), mobile devices, and the like. In some embodiments, the Tracing System 100 is implemented on multiple, different computers that can be connected through local network or internet to perform the functions.

For each instantiation of a given multimedia file, Core System Computer 110 produces one serial number and one corresponding barcode, as illustrated in Association Relation Table 120a. Barcode are attached to the file copies in distribution to merchants and ultimately, end customers. The Tracing System 100 requires that when the file copy is purchased, Merchant Computer 130 record the specification of the purchaser in Association Relation Table 120b linking the barcode attached to the file copy.

The Tracing System 100 thus can identify the source of duplicating by tracking the serial number assigned to a given file copy. By way of example, if a file copy with the serial number “2222222” is illegally duplicated, the Tracing System 100 can retrieve the serial number from the illegal copy of the file and reference the Association Relation Tables 120a & 120b to determine that Purchaser B was the origin of copying.

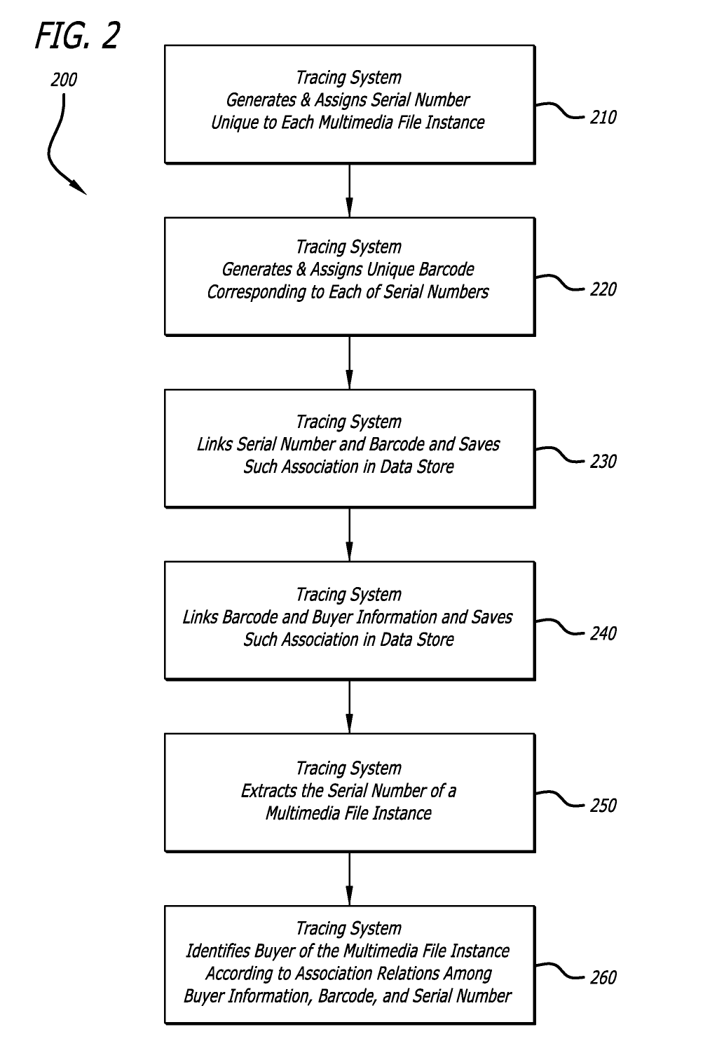

FIG. 2 is a flowchart 200 depicting functions of an exemplary embodiment of the Tracing System 100 according to the present invention. A unique serial number is first generated and assigned by the Tracing System 100 to an instance derived from a given multimedia file (Step 210). The Tracing System embeds and encodes the serial number into the digital data of the file instance, as will be described in further detail below.

Preferably, the Tracing System 100 produces and designates a barcode for the unique serial number associated with the instance of the multimedia file (Step 220). The barcode designated to the file instance favorably has no logical connection with the assigned serial number. The lack of logical connection heightens the difficulty to decrypt the coding of the Tracing System 100 to better protect its integrity. In a preferred embodiment according to the present invention, the serial number is hidden, i.e., not detectable by multimedia purchasers and the general public.

In some implementations, a barcode corresponds to multiple serial numbers each associated with an instance of a multimedia file. This approach might be necessary where one medium item such as CD-R, DVD-R and DVD-RW may carry multiple audio or audio-visual file instances while having only one barcode attached there to. The barcode can be engraved on various media such as CD-R, DVD-R or DVD-RW.

Referring to FIG. 2, after it links the file's serial number to a barcode, the Tracing System 100 saves such association relation in a database, preferably in a table or similar data structures, as shown in FIG. 1 (Step 230). The database table includes serial number field and barcode field, and in some embodiments also purchaser field. The purchaser field is empty originally and to be filled in with information of a purchaser when or after the transaction of the file instance is being processed.

When the file instance is purchased either online or through traditional channels such as retail stores, the Tracing System 100 requests for input identification of the buyer such as credit card information, license numbers or the like, that can ascertain the identity of the buyer and later track down the buyer if any unauthorized copying is made from the instance. The Tracing System 100 associates the buyer identification with the barcode and stores such association in, for instance, a database table, as shown in FIG. 1 (Step 240). The database table can be installed and kept on a seller's hard drive or memory of computer system, such as a personal computer or local network server, as an integral part of or in secure communication with the core computer of the Tracing System 100.

When unauthorized copying is discovered, the Tracing System 100 tracks down the source of copying by first extracting the unique serial number from the digital data of a file instance in question (Step 250). In some implementations, the System 100 extracts the serial number by reading and comparing the digital data of the instance to the data of the original multimedia file. Where the serial number is not embedded in the full file instance, the Tracing System 100 can calculate the changes based on comparison between the untouched parts of the multimedia instance and its original sound.

With the previous set up in its databases, the Tracing System 100 can match the extracted serial number to the instance's purchaser, by referencing the table associating the serial number with barcode and the table associating barcode with purchaser identification information (Step 260).

Various algorithms can be employed to embed the serial number designated to a given instance onto its digital data. The embedded data should be put in divisions of the instance where less noticeable to human ears.

Advantageously, the Tracing System 100 converts the serial number into binary codes 0's & 1's, and then modifies the intensity of audio sound in a given copy according to the binary codes. The intensity is preferably measured in decibels.

Provided below are three exemplary algorithms of changing the intensity of audio sound in a multimedia file instance based on its designated serial number:

Algorithm 1: Increasing decibel level;

Algorithm 2: Decreasing decibel level; and

Algorithm 3: Mixing of Algorithms 1 and 2 by both increasing and decreasing decibel level.

By way of example, Algorithm 1 can be implemented as follows:

(i) “Start” & “End” =3 dBs: increasing existing decibels of a file copy by 3 dBs as representations of Start & End;

(ii) “1” =2 dBs: increasing existing decibels of a file copy by 2 dBs corresponding to “1” in binary codes;

(iii) “0” =1 dB: increasing existing decibels of a file copy by 1 dB corresponding to “0” in binary codes; and

(iv) “Space” =not changing existing decibels of a file copy as representation of a space.

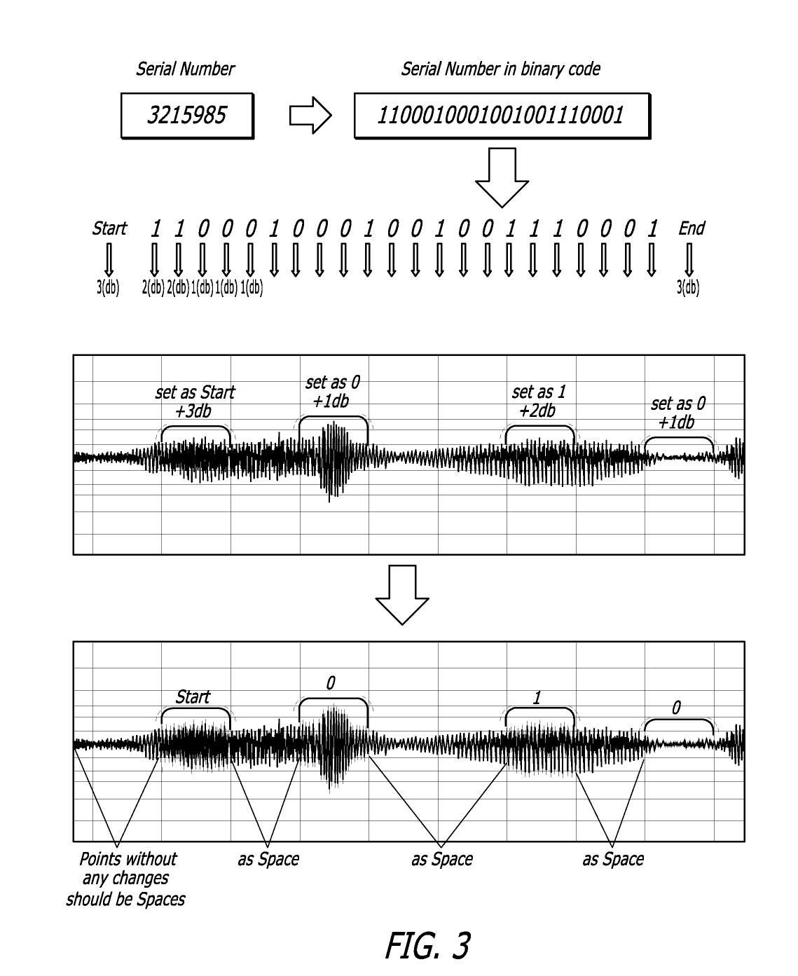

FIG. 3 depicts an example of embedding a given serial number to the digital data of a multimedia file copy in accordance with the current invention. It is to be noted that the embedded data should not cause harmful effect to the quality of the original multimedia file. In this example, the given serial number for the file instance is “3215985.” To embed the serial number onto the digital data of the instance, the digits have to be first converted to binary code stream—“1100010001001001110001.” The conversion is implemented preferably by software especially designed for this purpose and is well known by a person of ordinary skill in the relevant art.

The Tracing System 100 then modifies the audio intensity of the file copy one bit at a time according to the binary code stream. Based on the foregoing example of Algorithm 1, the Tracing System 100 adds to existing decibels of the copy, 3 dBs as a “Start” symbol preceding the binary code stream, and then 2 dBs corresponding to every bit “1” and 1 dB corresponding to every bit “0” till the “End” Symbol succeeding the binary code stream, represented as 3 dBs increase in audio intensity.

The approach illustrated in FIG. 3 is merely an example of modifying existing decibels of the multimedia data, i.e., in a continuous sequence. Depending on the multimedia content, the Tracing System 100 is designed to select parts of the multimedia data where modification would be least noticeable to human ears. Changes to the audio intensity do not necessarily apply to the whole or only parts of the file instance.

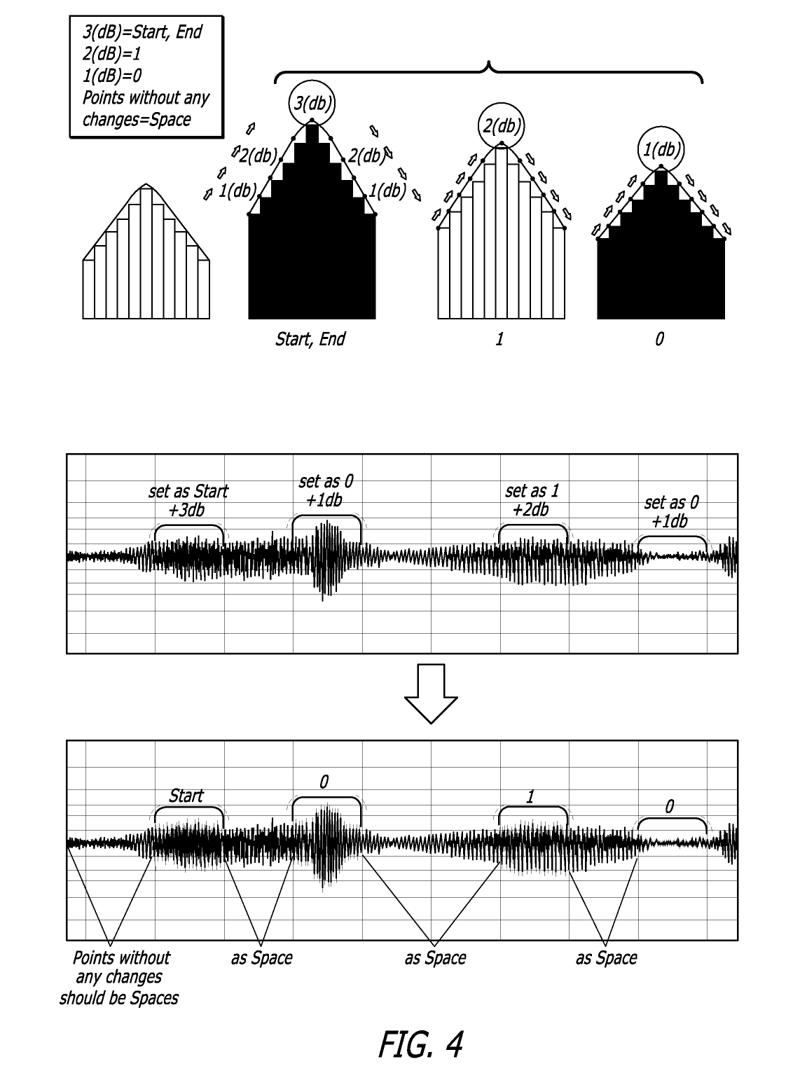

In a preferred embodiment, the modification on the audio intensity of a file copy is applied gradually to its data. Referring to FIG. 4, the increase or decrease on the audio intensity is made in increments to reach the maximum level of modification corresponding to the converted binary codes or “Start” and “End” representations.

Following the previous example referenced in FIG. 3, “Start” and “End” are represented as 3 dBs increase on the audio intensity of a file instance. Instead of increasing existing decibels at a given time point of the instance by 3 dBs at once, the Tracing System 100 adds to the original sound of the instance in each time interval only a portion of the 3 dBs, e.g., 0.5 dB, 1 dB, 1.5 dB, 2 dB, 2.5 dB, till reaching 3 dBs. The time intervals are preferably of equal lengths. Advantageously, the dB values added to the original sound are in arithmetic sequence, as shown in FIG. 4. Take binary code “1” for example, the decibel value corresponding to which is 2 units. Accordingly, the Tracing System 100 adds the following arithmetic series to the original sound of the file copy in equal time intervals—0.5 dB, 1 dB, 1.5 dBs, and 2 dBs.

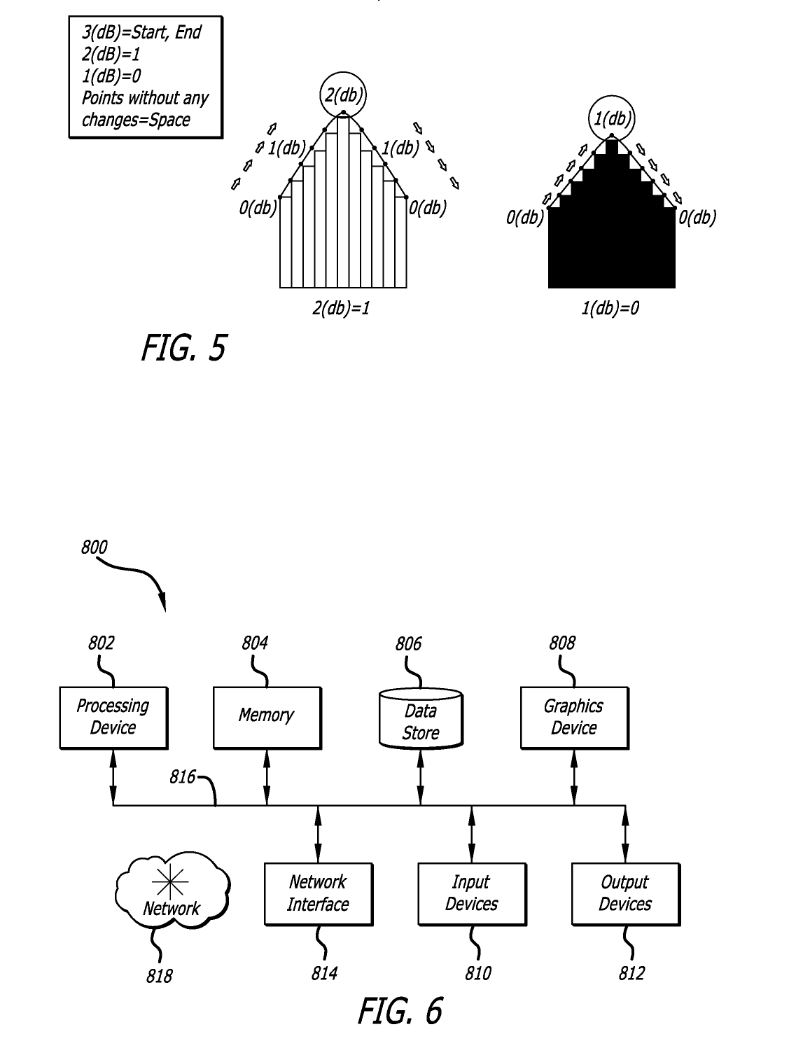

To discern the bits “0” and “1,” “Space” is advantageously inserted between decibel changes corresponding to the bits. Following the previous example, “Space” corresponds to the points where “no change in decibels” is applied. As the bits “0” and “1” shown in FIGS. 4 and 5 is represented by gradual modification on the audio intensity, appearing in peak shapes, “Space” would be required in between the peaks to avoid noise reading the data.

With introduction of the concept of “Spaces,” the audio modification corresponding to the converted binary codes can be allocated anywhere desirable in a given file copy. This approach can be used to make the changes in sound least noticeable to human ears.

FIG. 6 is a block diagram of an exemplary architecture 800 that the present invention can be implemented upon. The example architecture 800 includes at least one processing device 802 coupled to a bus system 816 to transmit data, such as a data bus and a mother board. The example architecture 800 further includes the following units connected to the bus system 816: data store 806, memory 804, input device 810, output device 812, graphics device 808, and network interface.

The processing device 802 for executing programs or instructions can be or include general and special purpose microprocessors that incorporate functions of a central processing unit (CPU) on a single integrated circuit (IC). The CPU controls an operation of reading the information from the data store 806, for example.

The data store 806 or memory 804 both serve as computer data storage for the example architecture 800 to buffer or store data, temporarily and permanently. The computer data storage refers to computer components, devices, and recording media that retain digital data used for computing for some interval of time. The data store device 806 typically includes non-volatile storage device such as magnetic disks; magneto-optical disks; and CD-ROM and DVD-ROM disks The memory 804 include all forms of non-volatile memory, including but not limited to semiconductor storage known as EPROM, EEPROM, flash memory devices, and dynamic random access memory, for example.

Examples for the input device 810 include a video camera, a keyboard, a mouse, a trackball, a stylus, etc.; and examples for output devices 812 can include a display device, an audio device, etc. The display monitors such as cathode ray tube (CRT) or liquid crystal display (LCD) monitor for displaying information to a user.

The graphics device 808 can, for example, include a video card, a graphics accelerator card, a graphics processing unit (GPU) or a display adapter, and is configured to generate and output images to a display device. In one implementation, the graphics device 808 can be realized in a dedicated hardware card connected to the bus system 816. In another implementation, the graphics device 808 can be realized in a graphics controller integrated into a chipset of the bus system 816.

The network interface 814 can, for example, include a wired or wireless network device operable to communicate data to and from a network 818. The network 818 may include one or more local area networks (LANs) or a wide area network (WAN), such as the Internet.

In one implementation, the system 800 includes instructions defining an operating system stored in the data store 806 and/or the memory 804. Example operating systems can include the MAC OS.®. X series operating system, the WINDOWS.®. based operating system, or other operating systems. Upon execution of the operating system instructions, access to various system objects is enabled. Example system objects include data files, applications, functions, windows, etc. To facilitate an intuitive user experience, the system 800 may include graphical user interface that provides the user access to the various system objects and conveys information about the system 800 to the user in an intuitive manner.

Having now described the invention in accordance with the requirements of the patent statutes, those skilled in this art will understand how to make changes and modifications in the present invention to meet their specific requirements or conditions. Such changes and modifications may be made without departing from the scope and spirit of the invention as set forth in the following claims.

What is claimed is:

1. A computer-implemented method for identifying and tracing copies of a file, comprising:
generating, respectively, a first identifier for each of the copies of the file;
designating a second identifier corresponding to the first identifier of the copy;
storing the association relation between the first identifier and the second identifier;
embedding the first identifier into the copy's data;
associating the second identifier with the copy's distribution information;
storing the association relation between the second identifier and the copy's distribution information;
reading the copy's data with the first identifier embedded therein and comparing the data to the original file to recover the first identifier; and
using the recovered first identifier to locate the copy's distribution information by referring to the association relations among the first identifier, the second identifier and the copy's distribution information.

2. The method of claim 1, further comprising:
converting the first identifier into binary codes;
designating a value in audio intensity respectively for bits “1” and “0”;
modifying audio intensity of the copy's data in accordance with the corresponding value for each of the binary codes.

3. The method of claim 1, wherein comparing the data to the original file includes calculating the first identifier based on comparison between unaffected portions of the data and the original file.

4. The method of claim 1, wherein the data portions with the first identifier embedded therein is in continuous sequence.

5. The method of claim 2, further comprising:
designating a value in audio intensity representing start and end of the modified data, wherein the value is distinguishable from the values representing bits 1 and 0; and
changing the audio intensity of the start and the end portions of the modified data with the value.

6. The method of claim 2, further comprising:
increasing and decreasing in increments audio intensity of the data in accordance with the corresponding values for each of the binary codes.

7. The method of claim 2, further comprising:
leaving unchanged audio intensity of a portion of the data subsequent to each portion of the data that has been modified corresponding to each of the binary codes.

8. The method of claim 1, wherein the second identifier is an optical machine-readable representation of data that is linked to the copy.

9. The method of claim 1, wherein the copy's distribution information includes credit card information of a purchaser of the copy.

10. A computer program product for identifying and tracing copies of a file, encoded on a computer-readable medium, operable to cause one or more processors to perform operations comprising:
generating, respectively, a first identifier for each of the copies of the file;
designating a second identifier corresponding to the first identifier of the copy;
storing the association relation between the first identifier and the second identifier;
embedding the first identifier into the copy's data;
associating the second identifier with the copy's distribution information;
storing the association relation between the second identifier and the copy's distribution information;
reading the copy's data with the first identifier embedded therein and comparing the data to the original file to recover the first identifier; and
using the recovered first identifier to locate the copy's distribution information by referring to the association relations among the first identifier, the second identifier and the copy's distribution information.

11. The product of claim 10, wherein the operations further comprise:
converting the first identifier into binary codes;
designating a value in audio intensity respectively for bits “1” and “0”;
modifying audio intensity of the copy's data in accordance with the corresponding value for each of the binary codes.

12. The product of claim 10, wherein comparing the data to the original file includes calculating the first identifier based on comparison between unaffected portions of the data and the original file.

13. The product of claim 10, wherein the data portions with the first identifier embedded therein is in continuous sequence.

14. The product of claim 11, wherein the operations further comprise:
designating a value in audio intensity representing start and end of the modified data, wherein the value is distinguishable from the values representing bits 1 and 0; and
changing the audio intensity of the start and the end portions of the modified data with the value.

15. The product of claim 11, wherein the operations further comprise:
increasing and decreasing in increments audio intensity of the data in accordance with the corresponding values for each of the binary codes.

16. The product of claim 11, wherein the operations further comprise:
leaving unchanged audio intensity of a portion of the data subsequent to each portion of the data that has been modified corresponding to each of the binary codes.

17. The product of claim 10, wherein the second identifier is an optical machine-readable representation of data that is linked to the copy.

18. The product of claim 10, wherein the copy's distribution information includes credit card information of a purchaser of the copy.
